(19) United States
(12) Patent Application Publication
(10) Pub. No.: US 2014/0316993 A1
(43) Pub. Date: Oct. 23, 2014

(54) MOBILE TERMINAL, TRANSACTION TERMINAL, AND METHOD FOR CARRYING OUT A TRANSACTION AT A TRANSACTION TERMINAL BY MEANS OF A MOBILE TERMINAL

(71) Applicant: TRUSTONIC LIMITED, Cambridge (GB)

(72) Inventor: Stephan Spitz, Munchen (DE)

(73) Assignee: TRUSTONIC LIMITED, Cambridge (DE)

(21) Appl. No.: 14/352,376

(22) PCT Filed: Sep. 26, 2012
(86) PCT No.: PCT/EP2012/004033

§ 371 Date: Apr. 17, 2014

(30) Foreign Application Priority Data
Oct. 20, 2011 (DE) 10 2011 116 489.1

(51) Int. Cl. G06Q 20/40; G06Q 20/38; H04M 1/725

(52) U.S. Cl. CPC G06Q 20/4012; H04M 1/72527; G06Q 20/3821
USPC 705/72

(57) ABSTRACT

The invention relates to a method for carrying out a transaction at a transaction terminal (40) by means of a mobile terminal (20), to such a transaction terminal (40), and to such a mobile terminal (20). The method has the step of identifying a user by means of the transaction terminal (40) and the step of authenticating the user with respect to the transaction terminal (40). The method is characterized in that the user is authenticated by checking whether a password, in particular a PIN, which is entered by the user via an input device (22, 24) of the mobile terminal (20) matches a password which is stored for the user in the transaction terminal (40) or in a background system (80) that is connected to said transaction terminal. A processor unit (33) in which a normal runtime environment (NZ) and a secured runtime environment (TZ) are implemented is provided in the mobile terminal (20), wherein an input device driver (34) is implemented in the secured runtime environment (TZ), said driver being designed to transmit inputs via the input device (22, 24) of the mobile terminal (20) to the secured runtime environment (TZ) of the processor unit (33) of the mobile terminal (20) in a secured manner for further processing.

The invention relates to a mobile terminal, in particular a mobile telephone, to a transaction terminal and to a method for carrying out a transaction at such a transaction terminal by means of such a mobile terminal.

A bank customer can use an EC, debit or credit card (referred to below as payment card or card for short) to carry out payment transactions at a terminal, for example to withdraw cash, to pay for his purchases without using cash, to purchase a ticket and the like. In order to withdraw cash, the customer inserts his payment card into the card reader of a transaction terminal in the form of a cash machine (also called automatic teller machine or ATM) and inputs his personal identification number (PIN) known only to him using a keypad of the cash machine. The cash machine is connected to a background system having an authorization center which checks the correctness of the PIN and decides on the disbursement of cash. If the customer has input the correct PIN, the amount selected by the customer is disbursed to the latter and the customer's account is debited with the disbursed amount.

A keypad called a “PIN pad” is generally used in cash machines to input the PIN. The PIN pad forms a unit together with encryption hardware of the cash machine and is configured in such a manner that the PIN never passes to the outside world in unencrypted form. The software for processing transactions which is implemented in the cash machine usually already operates only with an encrypted PIN, which naturally applies, above all, when forwarding requests to the authorization center of the background system.

There is a risk of “skimming attacks” when carrying out a transaction with a transaction terminal, in particular a cash machine, during which a PIN must be input using the keypad of the transaction terminal. A typical attack pattern during such a skimming attack is the simultaneous spying-out of the data for identifying the customer which are stored on a magnetic strip of the customer's payment card, for example the account number and/or the customer's name, together with the PIN, at a cash machine. The data from the customer's card are then typically copied to an empty card blank which can then be used by an attacker, together with the PIN, to withdraw cash from a cash machine. A skimming attack is therefore a replay attack. Since the card remains in the customer's possession, the latter generally notices such an attack only when collecting new bank statements or if the bank intervenes after the overdraft facility has been overdrawn, that is to say only after an attacker has already withdrawn cash from the customer's account and a loss has therefore occurred.

In the meantime, different variants of skimming attacks have become known in the case of cash machines, the common feature of which is the fact that the advancing miniaturization of the readers provided in a cash machine enormously simplifies the tampering with said readers. One variant involves directly attaching a reader in the form of a small plastic frame to the insertion shaft for the customer's payment card on the cash machine. The card is then easily pulled through the additional reader into the cash machine and the content of the magnetic strip of the card is read in the process. Another variant involves installing an additional reader in the door opener of a bank branch since access to the lobby of a bank branch, in which there is access to a cash machine, often already requires the card to be inserted.

The input of the PIN is usually filmed using a small radio camera which is concealed, for example, above the keypad of the cash machine in a plastic strip which has been stuck on. This strip is generally scarcely discernible, even to suspicious users. However, entire keypad dummies are also used, which are stuck over the actual keypad and simply record the keypad inputs by the customer, in particular his PIN.

Conventional approaches for warding off skimming attacks are generally complicated, user-unfriendly and/or may only partially prevent skimming attacks.

Against this background, the object of the invention is to provide a method for carrying out a transaction at a transaction terminal and a corresponding transaction terminal which provides comparatively simple and user-friendly protection against skimming attacks.

According to a first aspect of the invention, this object is achieved by means of a method for carrying out a transaction at a transaction terminal by means of a mobile terminal according to claim 1. According to a second aspect and a third aspect of the invention, the independent apparatus claims relate to a corresponding mobile terminal and a corresponding transaction terminal. Advantageous developments of the invention are defined in the subclaims.

The invention is based on the fundamental concept of moving the input of a password, in particular a PIN, for authenticating a customer, which is required when carrying out a transaction at a transaction terminal, in particular cash machines, from the keypad of the transaction terminal which is exposed to skimming attacks to a secure input device of a secure mobile terminal, preferably a secure mobile telephone, which communicates with the transaction terminal via a secure communication channel.

For this purpose, the secure mobile terminal comprises a processor unit in which a normal runtime environment and a secure, trusted runtime environment are implemented. In this case, the secure runtime environment is isolated from the normal runtime environment and is used to execute security-critical applications.

According to the invention, an input device driver for controlling the input device of the mobile terminal is implemented in the secure runtime environment of the mobile terminal and is configured to securely forward inputs, via the input device of the mobile terminal, to the secure runtime environment of the processor unit of the mobile terminal. This ensures that the communication path between the input device and the processor unit of the mobile terminal is eliminated as an attack area for tampering since the input device of the mobile terminal is securely connected to the trusted runtime environment of the processor unit.

The mobile terminal preferably also comprises a communication module which is configured to form the secure communication channel between the mobile terminal and the transaction terminal. In this preferred embodiment, a communication module driver is preferably also implemented in the secure runtime environment of the mobile terminal and is configured to securely transmit data provided by the processor unit to the transaction terminal via the communication module and the secure communication channel. This ensures that the communication path between the processor unit and the communication module of the mobile terminal is also eliminated as an attack area for tampering since the communication module is securely connected to the trusted runtime environment of the processor unit.

One preferred example of a secure runtime environment is the ARM® TrustZone® known from the prior art. In this case, a separate secure operating system, preferably the MobiCore® operating system which is likewise known, runs inside this TrustZone.

The mobile terminal preferably also comprises a display device which is controlled via a display device driver. The display device driver is preferably likewise implemented in the secure runtime environment of the processor unit. This is particularly advantageous in mobile terminals in which the input device and the display device are in the form of a touchscreen.

In the method according to the invention for carrying out a transaction at a transaction terminal, a customer is preferably identified with respect to the transaction terminal by means of a payment card, for example an EC, debit or credit card, by virtue of the payment card being inserted into the insertion shaft of the transaction terminal and being read there by a reader of the transaction terminal. The payment card preferably comprises a magnetic strip which stores an identification data element relating to the customer, which identification data element allows unique identification of the customer, for example a Primary Account Number (PAN), an account number, a card number, the customer's name and/or the like. It is likewise conceivable for the customer to be alternatively or additionally able to be identified in a contactless manner by means of his payment card, that is to say by means of secure communication between the payment card and the transaction terminal via the air interface.

If the transaction terminal allows different transactions to be selected, it is conceivable, according to preferred embodiments, for the customer to select the transaction desired by him, for example using a keypad or a touchscreen of the transaction terminal, after he has been identified with respect to the transaction terminal by means of his payment card and the data stored thereon, including at least one identification data element. However, it is likewise conceivable for this selection of a desired transaction to be carried out using the mobile terminal, for example using the input device of the mobile terminal, to be precise preferably after a secure communication channel has been formed between the mobile terminal and the transaction terminal.

After the customer has been identified using the identification data element and a transaction has possibly been selected by the customer, a secure communication channel is preferably set up between the transaction terminal and the communication module of the mobile terminal via the air interface. Within the scope of the present invention, a secure communication channel is understood as meaning a communication channel in which at least the security-relevant data, for example a PIN, are transmitted in encrypted form between the mobile terminal and the transaction terminal, for example using encryption methods.

The communication module of the mobile terminal and the transaction terminal are preferably configured in such a manner that the secure communication between the transaction terminal and the mobile terminal via the air interface is carried out according to a near-field communication standard or protocol, in which case the secure communication channel can be formed between the mobile terminal and the transaction terminal when the mobile terminal enters the near field of the transaction terminal. Preferred near-field communication standards or protocols are NFC, Bluetooth, RFID, WLAN, DECT, ZigBee or infrared. During the preferred use of communication according to the NFC standard, the transaction terminal preferably assumes the role of the NFC reader and the mobile terminal or its communication module assumes the role of an NFC tag or NFC transponder. Alternatively, the NFC communication between the transaction terminal and the mobile terminal may also be carried out in the peer-to-peer mode. However, instead of communication between the mobile terminal and the transaction terminal using a near-field communication standard or protocol, the mobile terminal and the transaction terminal may also communicate wirelessly with one another using other communication methods, for example using SMS.

At least one-sided authentication, for example in the form of challenge-response authentication, is preferably used when setting up a secure communication channel between the mobile terminal and the transaction terminal, during which authentication the transaction terminal must be authenticated with respect to the mobile terminal. This ensures that the mobile terminal actually communicates with a transaction terminal and not with a communication device which belongs to an attacker and poses as a transaction terminal.

Another preferred embodiment provides for the mobile terminal to also have to be authenticated with respect to the transaction terminal, to be precise preferably using challenge-response authentication again. The advantage of this preferred embodiment is, in particular, the fact that the transaction terminal can check whether it is communicating with the mobile terminal belonging to the customer identified by his payment card or with another mobile terminal, for example the mobile terminal belonging to a potential attacker. In the latter case, provision is preferably made for the transaction terminal to refuse to carry out the transaction.

In order to carry out the authentication, suitable electronic keys can be stored in the transaction terminal (or the background system connected to the transaction terminal) and in the mobile terminal. These are preferably authentication keys with an individual key for a respective mobile terminal and a corresponding key for the transaction terminal which is stored, for example, in the background system together with the identification data element for a customer.

After a secure communication channel has been formed between the transaction terminal and the communication module of the mobile terminal, the input device of the mobile terminal can be enabled for the input of a password, preferably a PIN. In this case, a corresponding indication can be made on a display device of the transaction terminal and/or the display device of the mobile terminal. Alternatively or additionally, the customer can be requested to input the password using the secure input device of the mobile terminal using another signal, for example using a ring tone.

The password input by the customer using the secure input device of the mobile terminal is transmitted to the transaction terminal via the communication module and the secure communication channel. In this case, the password is preferably not transmitted in plain text but rather in encrypted form, in which case the encryption can be based on the authentication keys.

According to one preferred embodiment, the authentication keys are used in this case as a respective master key in order to derive a new respective session key for each transaction. A respective session key can be generated, for example, by virtue of the mobile terminal and the transaction terminal interchanging a random number and this random number respectively being encrypted with the master key stored in the mobile terminal or the master key stored in the transaction terminal.

After it has been checked that the password input by the customer using the input device of the mobile terminal and transmitted to the transaction terminal via the secure communication channel is the same as the password stored in conjunction with the identification data element in the transaction terminal and/or a background system connected to the transaction terminal, the transaction desired by the customer, for example withdrawing cash, is enabled by the transaction terminal and/or the background system connected to the transaction terminal.

A transaction application (also called a transaction trustlet within the scope of the MobiCore® operating system) preferably runs in the secure runtime environment of the mobile terminal and controls, that is to say carries out and/or prompts, the steps needed to carry out a transaction according to the invention by the mobile terminal.

According to alternative embodiments, it is conceivable for the functions of the payment card, in particular for identifying the customer, to be integrated in the customer's mobile terminal. In this case, the customer is not identified in a contact-based or contactless manner using the payment card but rather using an identification data element which is stored in the mobile terminal and uniquely identifies the mobile terminal or the customer.

As a person skilled in the art discerns, the present invention can be advantageously used in a multiplicity of cases, for example during transactions, such as the withdrawing or depositing of cash, or else in cashless payment transactions, for example during payment operations using a payment card in which it is necessary to input a PIN. Accordingly, in the sense of the present invention, a transaction terminal may be a cash machine (ATM) for withdrawing and/or depositing cash, a POS terminal (“Point of Sale terminal”) for cashless payment at a point of sale, a bank service terminal, for example for carrying out transfers, a ticket terminal or the like. The secure mobile terminal may be, in particular, a mobile telephone, a smartphone, a PDA (Personal Digital Assistant) or the like.

The preferred refinements described above can be advantageously implemented within the scope of the first aspect of the invention, that is to say within the scope of the method for carrying out a transaction at a transaction terminal, within the scope of the second aspect of the invention, that is to say within the scope of a mobile terminal configured for this purpose, and within the scope of the third aspect of the invention, that is to say within the scope of an accordingly configured transaction terminal.

Further features, advantages and objects of the invention emerge from the following detailed description of a plurality of exemplary embodiments and alternative embodiments. Reference is made to the drawings, in which:

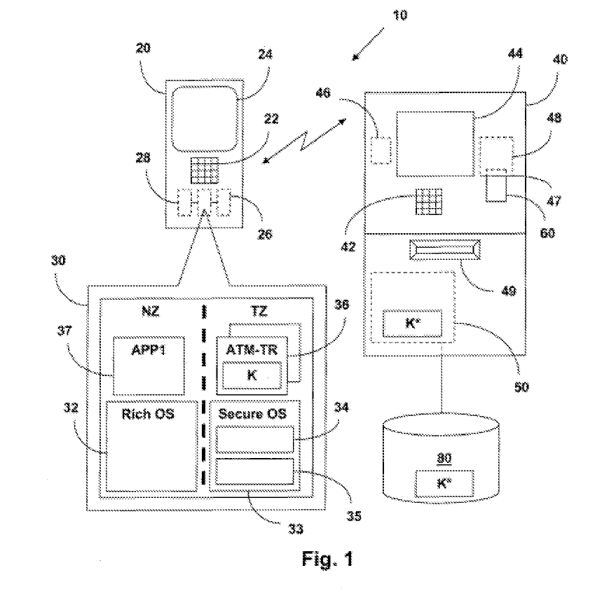

FIG. 1 shows a schematic illustration of a preferred embodiment of a mobile terminal and a transaction terminal as part of a transaction system, and

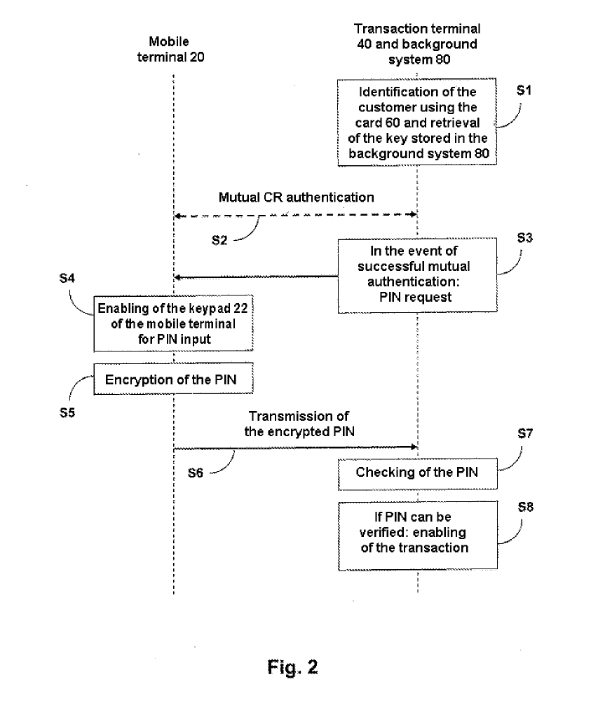

FIG. 2 shows a schematic illustration of a preferred embodiment of a transaction method according to the invention.

FIG. 1 shows a schematic illustration of a mobile terminal 20 in the form of a mobile telephone and a transaction terminal 40 in the form of a cash machine for carrying out a transaction, in particular for withdrawing cash. The mobile terminal 20 and the transaction terminal 40 are part of a transaction system 10 which also comprises, in particular, a background system 80 which is connected to the transaction terminal 40. The background system 80 securely stores a multiplicity of data items which can be accessed by a multiplicity of transaction terminals, for example the transaction terminal 40, connected to the background system 80.

The mobile terminal 20 in the form of a mobile telephone comprises an input device or keypad 22 for user inputs and a display or display device 24 for displaying information. The keypad 22 and the display 24 may also be in the form of a touchscreen. The mobile terminal 20 also comprises a communication module 26 which is preferably configured to form a secure NFC communication channel with the transaction terminal 40. For the preferred case illustrated in FIG. 1 in which the mobile terminal 20 is a mobile telephone, the mobile terminal 20 preferably also comprises a mobile radio module 28, for example a SIM card, for communication via a mobile radio network.

The mobile terminal 20 in the form of a mobile telephone also comprises a processor unit 30, for example a microcontroller, which is configured to suitably control the different components of the mobile terminal 20. For the sake of clarity, the architecture of the processor unit 30 is schematically illustrated again in detail outside the mobile terminal 20 in FIG. 1.

A normal, non-secure runtime environment NZ (“Normal Zone”) and a secure runtime environment TZ (“TrustZone”) in the form of a so-called ARM® TrustZone® are implemented in the processor unit 30. The ARM® TrustZone® is a system architecture which was developed by the company ARM® and provides a “secure”, trusted area and a “normal” area which is generally untrusted. In this case, it is monitored whether the processor unit is operated in the trusted area or in the untrusted area. A changeover between the trusted area and the untrusted area is also monitored.

In the preferred embodiment described here, a secure operating system 33 (Secure OS), preferably the MobiCore® operating system known from the prior art, runs in the TrustZone TZ. In contrast, the normal runtime environment NZ contains a conventional mobile telephone operating system 32. If the mobile terminal 20 is a smartphone, the operating system 32 implemented in the normal runtime environment NZ is a so-called “Rich OS” with an extensive range of functions. Such an operating system of the mobile terminal 20 may be, for example, Android, Apple iOS, Windows phone or the like.

The TrustZone TZ is used to execute security-critical applications and services with the aid of the mobile terminal 20. In this case, applications are understood as meaning functionalities remote from the operating system, for example transaction routines for bank transactions or payment transactions, for example. Services are understood as meaning functionalities close to the operating system, for example drivers for the keypad 22 or the display 24 of the mobile terminal 20 or encryption functionalities.

In this case, the secure runtime environment TZ is isolated from the normal runtime environment NZ and encapsulates security-critical processes, thus achieving efficient protection from attacks by unauthorized third parties. The security-critical applications running inside the TrustZone TZ are referred to as trustlets, in which case FIG. 1 portrays the trustlet 36 (“ATM-TR”) by way of example. In contrast to this, conventional applications run in the normal runtime environment NZ, in which case an application 37 (“APP1”) is indicated in FIG. 1 by way of example. The applications and services from the untrusted area NZ, for example the application 37 (“APP1”), do not have access to the applications and services in the trusted area TZ, for example the trustlet 36 (“ATM-TR”).

As services which are close to the operating system, a keypad driver 34 and a communication module driver 35 are preferably implemented in the TrustZone TZ. The keypad driver 34 is configured to securely forward inputs, via the keypad 22 of the mobile terminal 20, to the secure runtime environment TZ of the processor unit of the mobile terminal 20. This ensures that the communication path between the keypad 22 and the processor unit 30 of the mobile terminal 20, which is a potential security gap, is eliminated as an attack area for tampering since the keypad 22 of the mobile terminal 20 is securely connected to the trusted runtime environment TZ of the processor unit 30. The communication module driver 35 is configured to securely transmit data provided by the processor unit 30 to the transaction terminal 40 via the communication module 26. This ensures that the communication path between the processor unit 30 and the communication module 26 of the mobile terminal 20 is also eliminated as an attack area for tampering since the communication module 26 is securely connected to the trusted runtime environment TZ of the processor unit 30.

Although the implementation of a display driver in the trusted area TZ is generally considerably more complex, on account of the number of available displays for mobile terminals and subcomponents for controlling these displays, for example graphics cards, than the implementation of a keypad driver, such as the keypad driver 34, for example, a display driver (not illustrated) can also be implemented in the TrustZone TZ in addition to the keypad driver 34 and the communication module driver 35. In this case, the display driver is configured to securely transmit data provided by the processor unit 30 to the display 24 and to have said data displayed on the display. This ensures that the communication path between the processor unit 30 and the display 24 of the mobile terminal 20 is also eliminated as an attack area for tampering since the display 24 is securely connected to the trusted runtime environment TZ of the processor unit 30.

As already described above, the mobile terminal 20 can preferably communicate with the transaction terminal 40 according to the NFC standard via the air interface using the communication module 26. For this purpose, the transaction terminal 40 also has a corresponding communication module 46 which is suitable for communicating according to the NFC standard.

The transaction terminal 40 which, in preferred embodiments, may have the form of a conventional cash machine also comprises a keypad 42 for the input of data and instructions by the customer, for example in the form of a PIN pad, a display 44 for displaying information and selection options for a customer, for example, and an insertion shaft 47 for inserting a payment card 60 into the transaction terminal 40. In a known manner, a component of the transaction terminal 40 which is in the form of a reader 48 reads the data from a payment card 60 inserted into the insertion shaft 47, which data are preferably stored on a magnetic strip of the payment card 60. The transaction terminal 40 also comprises a cash dispensing compartment 49 which can be used to dispense the amount of cash desired by a customer if the transaction selected by the customer is enabled by the transaction terminal 40. Although the transaction terminal 40 illustrated in FIG. 1 has a keypad 42 in the form of a PIN pad according to one preferred embodiment of the invention, with the result that the transaction terminal 40 in principle could also be operated in a conventional manner, it is likewise conceivable for the keypad 42 to be omitted or to be combined together with the display 44 to form a touchscreen.

In order to suitably control the different components of the transaction terminal 40, the transaction terminal 40 also comprises an electronic control unit which may be a processor unit, for example. The control unit 50 of the transaction terminal 40 preferably communicates with its communication module and with a background system 80 in such a manner that the preferred embodiment of a transaction method which is described below with reference to FIG. 2 can be carried out by means of the mobile terminal 20, the transaction terminal 40 and possibly the background system 80.

FIG. 2 illustrates the individual steps which are carried out by the mobile terminal 20 and the transaction terminal 40 or the background system 80 connected to the latter in a preferred embodiment of a method for carrying out a transaction, in particular a method for withdrawing cash.

In a first step S1, a customer is identified with respect to the transaction terminal 40 preferably by virtue of the fact that the customer inserts his payment card 60 into the insertion shaft 47 of the transaction terminal 40 and at least one identification data element for uniquely identifying the customer, which is stored on a magnetic strip of the payment card 60 for example, is read by the reader 48 of the transaction terminal 40. In this case, the customer's Primary Account Number (PAN) which is stored on the magnetic strip of the payment card 60 is preferably read by the reader 48 of the transaction terminal 40 and is forwarded to the background system 80. A data record which is associated with the read identification data element and preferably comprises at least the PIN and an individual electronic key K* is then determined in the background system 80.

In step S2 of FIG. 2, mutual challenge-response authentication is preferably carried out between the mobile terminal 20 and the transaction terminal 40 on the basis of the key K* stored in the background system and the key K stored in the secure runtime environment TZ of the processor unit 30 of the mobile terminal 20. As is known to a person skilled in the art, in order to authenticate the mobile terminal 20 with respect to the transaction terminal 40, the transaction terminal 40 may transmit, for example, a random number to the mobile terminal 20, which random number is then encrypted by the mobile terminal 20 in accordance with an agreed encryption algorithm using the key K stored in the secure runtime environment TZ and the result of this encryption is transmitted to the transaction terminal 40 again. The procedure is similar in the transaction terminal 40 and/or the background system 80 connected to the transaction terminal, that is to say the random number transmitted by the transaction terminal 40 to the mobile terminal 20 is encrypted using the key K* stored in the background system 80 and a check is carried out in order to determine whether the result of this encryption is the same as the encrypted random number transmitted by the mobile terminal 20. If this is the case, the transaction terminal 40 can assume that the key K stored in the mobile terminal 20 is the same as the key K* stored in the background system 80 and the mobile terminal 20 is therefore authentic. As is known to a person skilled in the art, the transaction terminal 40 can be authenticated with respect to the mobile terminal 20 in a corresponding manner, that is to say by virtue of the mobile terminal 20 transmitting a random number to the transaction terminal 40 and this random number being encrypted both by the mobile terminal 20 and by the transaction terminal 40.

A person skilled in the art is aware of a multiplicity of methods regarding how the keys K and K* can be securely stored both in the mobile terminal 20 and in the transaction terminal 40 or in the background system 80 connected to the transaction terminal. For example, this can be carried out when producing and/or personalizing the mobile terminal 20. If the mobile terminal is already in the field, secure OTA methods can be additionally or alternatively used, as are used when personalizing SIM cards in the field, for example.

After the transaction terminal 40 and the mobile terminal 20 have been mutually authenticated in step S2 of FIG. 2, the transaction terminal 40 transmits a request to input the PIN to the mobile terminal 20 in step S3 of FIG. 2. The keypad 22 of the mobile terminal 20 is then preferably enabled for PIN input (see step S4 of FIG. 2) and a corresponding indication is displayed on the display 24 of the mobile terminal 20 in order to prompt the customer to input his PIN using the secure keypad 22 of the mobile terminal 20. After the customer has input his PIN using the secure keypad 22 of the mobile terminal 20, this PIN is encrypted in step S5 of FIG. 2 using an encryption algorithm agreed with the transaction terminal 40 and is transmitted to the transaction terminal 40 in encrypted form (step S5 of FIG. 2).

In the preferred embodiment of a method according to the invention for carrying out a transaction, as illustrated in FIG. 2, the encryption and decryption of the PIN, in particular, are likewise based on the keys K and K*. However, a person skilled in the art will discern that secret keys other than the keys K and K* can also be used for the authentication and the encryption of the data transmitted between the mobile terminal 20 and the transaction terminal 40 via the communication channel.

In order to increase security, in the preferred embodiment of a method according to the invention for carrying out a transaction, as illustrated in FIG. 2, the keys K and K* are used as a respective master key in order to derive a respective new session key for each transaction. A respective session key can be generated, for example, by virtue of the mobile terminal 20 and the transaction terminal 40 interchanging a further random number and this random number respectively being encrypted with the key K stored in the mobile terminal 20 and the key K* stored in the transaction terminal 40 (or in the background system 80 connected to the transaction terminal) according to an agreed encryption algorithm. The PIN input by the customer using the keypad 22 of the mobile terminal 20 is encrypted using the session key created in the mobile terminal 20 in this manner in step S5 of FIG. 2 and is transmitted to the transaction terminal 40 (step S6 of FIG. 2).

After it has been determined, in step S7 of FIG. 2, that the PIN input by the customer using the keypad 22 of the mobile terminal 20 and transmitted to the transaction terminal 40 via the secure communication channel is the same as the PIN stored in conjunction with the identification data element in the transaction terminal 40 and/or the background system 80 connected to the transaction terminal, the transaction desired by the customer, for example withdrawing cash, is enabled by the transaction terminal 40 and/or the background system 80 connected to the transaction terminal (step S8 of FIG. 2). In this case, depending on how the PIN is stored in the background system 80, the check can be carried out by the transaction terminal 40 and/or the background system 80 connected to the transaction terminal directly using the encrypted PIN transmitted by the mobile terminal 20 or using the PIN which results from the decryption of the encrypted PIN transmitted by the mobile terminal 20. In other words: embodiments are conceivable in which the encrypted PIN transmitted by the mobile terminal 20 is decrypted using the key K* before step S7 of FIG. 2.

As a person skilled in the art discerns, if the transaction terminal 40 allows the selection of different transactions and/or alternatives, for example the selection of the amount of cash which the customer would like to withdraw, provision may be made of a further step (not illustrated in FIG. 2) in which the customer makes this selection. This selection is preferably made by the customer after step S7, that is to say after his PIN has been verified, but may also already be made at an earlier time. The selection of the transaction desired by the customer can be made using the keypad 42 or the display 44 of the transaction terminal 40, which is in the form of a touchscreen, and/or using the keypad 22 or the display 24 of the mobile terminal 20, which is in the form of a touchscreen.

As indicated in FIG. 1 and already described above, the application (or the trustlet in the case of the MobiCore® operating system) 36 (“ATM-TR”) runs in the secure runtime environment of the mobile terminal 20 and is configured to carry out or prompt the method steps described above with reference to FIG. 2, in particular by the mobile terminal 20. For example, the application 36 (“ATM-TR”) is configured to carry out or prompt the mutual challenge-response authentication with the transaction terminal in step S2 of FIG. 2 and the encryption of the PIN input using the keypad 22 of the mobile terminal 24.

Although it has been described above, with respect to the preferred embodiments illustrated in FIGS. 1 and 2, that the customer is first of all identified by virtue of the fact that the customer inserts his payment card 60 into the insertion shaft 47 of the transaction terminal 40 and this card is read by the reader 48 of the transaction terminal 40, embodiments are likewise conceivable in which the customer can be alternatively or additionally identified in a contactless manner using his payment card 60, that is to say by means of communication between the payment card 60 and the transaction terminal 40 via the air interface.

Embodiments of the invention are also conceivable in which the payment card 60 used to identify the customer is entirely dispensed with and its functions are integrated in the mobile terminal 20 or in components of the latter. For example, a customer could already be identified by contactlessly reading an identification data element stored on the mobile terminal 20. Suitable conceivable identification data elements here would be: a unique chip number of the communication module 26 or of the processor unit 33 of the mobile terminal 20 or a unique serial number stored in a memory of the communication module 26 or of the processor unit 33, for example an EPC (“Electronic Product Code”) or a UII (“Unique Item Identifier”). If the mobile terminal 22 is designed for communication via a mobile radio network and comprises a corresponding secure mobile radio module 28, for example in the form of a SIM or the like, the identification data element may also be the IMSI (“International Mobile Subscriber Identity”) of the mobile radio module 28 or the unique telephone number allocated to the mobile terminal 20.

### LIST OF REFERENCE SYMBOLS

10 Transaction system
20 Mobile terminal
22 Keypad of the mobile terminal
24 Display of the mobile terminal
26 Communication module of the mobile terminal
28 Mobile radio module
30 Processor unit
NZ Non-secure runtime environment (NormalZone)
TZ Secure runtime environment (TrustZone)
32 Non-secure operating system (Rich OS)
33 Secure operating system (Secure OS)
34 Keypad driver
35 Communication module driver
36 Transaction application (ATM-APP)
37 Application
40 Transaction terminal
42 Keypad of the transaction terminal
44 Display of the transaction terminal
46 Communication module of the transaction terminal
47 Insertion shaft
48 Reader
49 Cash dispensing compartment
50 Control unit
60 Payment card
80 Background system
K, K* Electronic keys

1. A method for carrying out a transaction at a transaction terminal (40) by means of a mobile terminal (20), wherein the method comprises the following steps:
identifying a user by means of the transaction terminal (40); and
authenticating the identified user with respect to the transaction terminal (40) by checking whether a password, in particular a PIN, input by the identified user using an input device (22, 24) of the mobile terminal (20) matches a password stored for the identified user in the transaction terminal (40) or in a background system (80) connected to the transaction terminal,
wherein a processor unit (33) is provided in the mobile terminal (20), in which processor unit a normal runtime environment (NZ) and a secure runtime environment (TZ) are implemented, wherein an input device driver (34) is implemented in the secure runtime environment (TZ) and is configured to securely forward inputs, via the input device (22, 24) of the mobile terminal (20), to the secure runtime environment (TZ) of the processor unit (33) of the mobile terminal (20) for further processing.

2. The method as claimed in claim 1, wherein a secure communication channel is formed between the mobile terminal (20) and the transaction terminal (40) during the step of authenticating the user, in which at least the security-relevant data are transmitted in encrypted form using encryption methods, and communication via the secure communication channel is preferably effected according to the NFC standard.

3. The method as claimed in claim 2, wherein a communication module driver (35) is implemented in the secure runtime environment (TZ) for the purpose of forming a secure communication channel between the mobile terminal (20) and the transaction terminal (40) and is configured to securely transmit data provided by the processor unit (33) to the transaction terminal (40) via a communication module (26) of the mobile terminal (20) and the secure communication channel.

4. The method as claimed in claim 1, wherein, during the step of identifying a user by means of the transaction terminal (40), an identification data element which is stored on a payment card (60) belonging to the user and uniquely identifies the user is read in a contact-based or contactless manner by a reader (48) of the transaction terminal (40), or an identification data element which is stored on the mobile terminal (20) and uniquely identifies the user or the mobile terminal (20) is read.

5. The method as claimed in claim 2, wherein, before the step of authenticating the user, at least one-sided authentication, preferably mutual authentication, for example in the form of challenge-response authentication, is used between the communication module (26) of the mobile terminal (20) and the transaction terminal (40), during which authentication the transaction terminal (40) must be authenticated with respect to the mobile terminal (20) and/or the mobile terminal (20) must be authenticated with respect to the transaction terminal (40).

6. The method as claimed in claim 5, wherein authentication keys (K, K*) stored in the mobile terminal (20) and in the transaction terminal (40) and/or in a background system (80) connected to the latter are used to carry out the authentication by the mobile terminal (20) and/or the transaction terminal (40), wherein the key (K) stored in the mobile terminal (20) is an individualized key.

7. The method as claimed in claim 6, wherein communication via the secure communication channel between the mobile terminal (20) and the transaction terminal (40) is encrypted on the basis of the authentication keys (K, K*), wherein the authentication keys (K, K*) are preferably used as a respective master key in order to derive a new respective session key for each transaction.

8. The method as claimed in claim 1, wherein the secure runtime environment (TZ) is an ARM® TrustZone® in which the secure MobiCore® operating system preferably runs.

9. The method as claimed in claim 1, wherein the mobile terminal (20) is a mobile telephone and the operating system of the mobile telephone runs in the normal runtime environment (NZ).

10. A mobile terminal (20) for carrying out a transaction at a transaction terminal (40), wherein the mobile terminal (20) comprises:
an input device (22, 24) for inputting a password, in particular a PIN, by a user; and
a processor unit (33) in which a normal runtime environment (NZ) and a secure runtime environment (TZ) are implemented, wherein an input device driver (34) is implemented in the secure runtime environment (TZ) and is configured to securely forward inputs, via the input device (22, 24) of the mobile terminal (20), to the secure runtime environment (TZ) of the processor unit (33) of the mobile terminal (20) for further processing, and wherein an application (36) is also implemented in the secure runtime environment (TZ) of the processor unit (33) and is configured to make it possible to authenticate the user with respect to the transaction terminal (40) by checking whether the password input by the user using the input device (22, 24) of the mobile terminal (20) matches a password stored for this user in the transaction terminal (40) or in a background system (80) connected to the transaction terminal.

11. A transaction terminal (40) for carrying out a transaction by means of a mobile terminal (20), wherein the transaction terminal (40) comprises:
a control unit (50) which is configured to identify a user; and
a communication module (46) for forming a secure communication channel between the mobile terminal (20) and the transaction terminal (40),
wherein the transaction terminal (40) is configured to authenticate the user in such a manner that a check is carried out in order to determine whether a password, in particular a PIN, input by the user using an input device (22, 24) of the mobile terminal (20) matches a password stored for the identified user in the transaction terminal (40) or in a background system (80) connected to the transaction terminal.

12. A system (10) for carrying out a transaction at a transaction terminal (40) as claimed in claim 11.
